(19) United States
(12) Patent Application Publication
(10) Pub. No.: US 2011/0235061 A1
(43) Pub. Date: Sep. 29, 2011

(54) METHOD FOR PREPARING A MAIL ITEM INCLUDING AN ENVELOPE

(75) Inventor: Esko Maaranen, Helsinki (FI)

(73) Assignee: MAIL SYSTEMS OY, Helsinki (FI)

(21) Appl. No.: 13/131,439

(22) PCT Filed: Oct. 9, 2009
(86) PCT No.: PCT/FI2009/050803

§ 371 Date: May 26, 2011

(30) Foreign Application Priority Data
Nov. 27, 2008 (FI) 20086141

(51) Int. Cl. G06K 15/02

(52) U.S. Cl. 358/1.1

(57) ABSTRACT

A method for preparing a mail item including an envelope from two rectangular sheets (1,2) of different sizes in a printer (3) and a folding machine (4) coupled after the printer. The method uses a file (5) containing envelope information and letter information to be printed and, controlled by the file, sheets are selectively taken from sheet feeder devices (6,7) of the printer in a successive train, wherein the envelope information is printed on a larger envelope sheet (1) and the letter information is printed on a smaller letter sheet (2), the printing on the employed sheets being carried out in a successive train in one printer. The envelope sheet (1) and the letter sheet (2) are both led from the sheet feeder devices (6,7) into the printer (3) and from the printer after printing as such, uncut and uncoded, to folding (4) wherein, controlled by the sheet size, the envelope sheet is glued and folded to form an open envelope into which the letter sheet of the same mail item is folded, whereupon the envelope is closed to form a finished closed mail item (8).

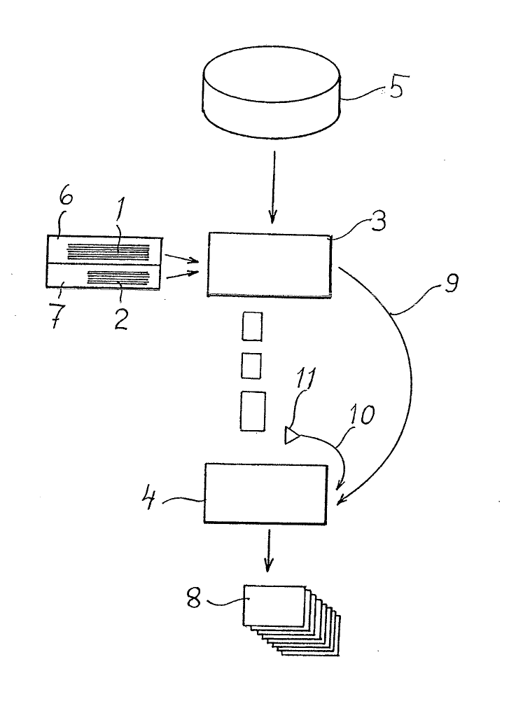

### FIELD OF THE INVENTION

The invention relates to a method for preparing a mail item as defined in the preamble of claim 1.

### BACKGROUND OF THE INVENTION

The closest prior art of the invention is disclosed in document WO2008067601 A1. Known from that document is a method for preparing ready-printed mail items enclosed in an envelope. The method is based on a printer provided with two sheet feeds, which prints alternately or in a suitable order letter sheets on which letter information and code information have been printed and envelope sheets on which envelope information and code information have been printed. Based on the code information printed on the sheets, the sheets are then identified after the printer and sorted so as to form the envelope sheets into envelopes by gluing and folding and to fold the desired letters inside the envelopes.

The method described in the document is functional as such, but it comprises some drawbacks which limit or impede varied use of the method. In the method, all sheets of paper to be printed are coded so as to identify them for later processing. The employed, normally optically readable, codes are not stylish in otherwise individualized mail items and give them the appearance of mass mailing. An even more important drawback relates to reading of the codes and to errors caused during reading. Errors may occur during printing of the codes which make their reading impossible. Impurities may present themselves over the code, which causes reading errors. Impurities may present themselves in the optical reading devices, which causes reading errors. Therefore, it can be stated that the most damageable part of the known method are the codes to be printed on the sheets, and their use.

### OBJECTIVE OF THE INVENTION

The objective of the invention is to eliminate the drawbacks of the prior art referred to above. In particular, the objective of the invention is to provide a method wherein separately printed codes are not needed on the sheets, so that all problems and drawbacks caused by the codes can be avoided.

### SUMMARY OF THE INVENTION

The method according to the invention is designed for the preparation of a mail item including an envelope from rectangular sheets of two different sizes which may be partly ready-printed or impressed or completely blank sheets. The mail item is prepared from the sheets in a printer and a folding machine coupled after the printer. Two sheet feeder devices are used in the printer to feed two sheets of different sizes to the printer alternately or in a suitable successive order. In this context, a sheet feeder device refers widely to sheet feeder trays, boxes or other spaces integrally included in a printer, as well as to separate devices for feeding sheets to a printer.

The method uses a file containing envelope information and letter information to be printed. Controlled by the file, sheets are picked selectively in a successive train from the sheet feeder devices, wherein the envelope information is printed on a larger or an envelope sheet, and the letter information is printed on a smaller or a letter sheet. Thus, printing is carried out on the employed sheets in a successive train in one printer.

According to the invention, the envelope sheet and the letter sheet are both led from the respective sheet feeder devices to the printer and from the printer after printing as such, uncut and uncoded, to folding. In the folding, controlled by the sheet size and/or a signal provided by the printer, the envelope sheet is glued and folded as such, uncut, to form an open envelope. Then, a folded letter sheet of the same mail item is inserted into the envelope either in connection with the folding of the envelope or into a finished envelope. Finally, the envelope is closed by gluing the flap to form a finished closed mail item.

Thus, it is characteristic of the invention that no codes or such other marks are printed on the envelope sheets or the letter sheets which are designed merely to identify them and differentiate between them. As no additional codes are used, there is no need to read codes and no need for any code reading devices. This is significantly contributive in simplifying the process and reducing various defects and malfunctions.

It is also characteristic of the invention that right-sized sheets of two different sizes are used outright so that there is no need to cut them at any point. In this manner, there is no need to use cutters, one is spared the maintenance and noise of the cutters, and no waste cuts or dust is produced by cutting. Furthermore, the entire process becomes faster because the slowest part of the process which requires the most maintenance is eliminated.

Preferably, the control by sheet size is provided by a signal from the printer. Thus, printing and folding are arranged to be substantially continuous sequential operations wherein the envelope sheet which has been conveyed from the printer is folded immediately to form an envelope and the letter sheet which has been conveyed from the printer is folded immediately to form a letter, either separately or so that the envelope sheet and the associated letter sheets are collated and folded together to form an envelope including the letters. No coding or code reading is needed.

Another option is that the control by sheet size is provided by a detector in connection with folding, identifying the size of a sheet that is entering the folding. For example, a suitable optical detector can be used so as to differentiate between the sheet sizes. One advantageous way is to identify only the larger envelope sheets, whereby the unidentified sheets are processed as letter sheets, or the other way round, whereby only the smaller letter sheets are identified.

In one embodiment of the invention, one mail item comprises a number of letter sheets to be printed, i.e. one envelope includes a number of letters. In this case, the envelope sheet and all associated letter sheets are printed and processed in a successive train and preferably folded in one block to form an open envelope which is then closed.

Thus, the essential feature in the method according to the invention is that after printing of the sheets, the ready-printed envelope sheets or letter sheets are not stored or collected in blocks and their movement in the process is not slowed down in any other manner.

In this way, they do not need to be coded or specifically identified at a later stage so as to know what to do with them or where to lead them. The control of the printed sheets is carried out in the process as continuous and unbroken control, preferably by internal electrical signals of the process.

Depending on the structure and operation of the employed folding machine, in one embodiment the envelope sheet is first printed and led to folding, followed by the letter sheets of the same mail item. In another embodiment, on the other hand, the letter sheet or all letter sheets of the same mail item are first printed and led to folding, followed by the envelope sheet of that same mail item.

The method according to the invention provides considerable advantages as compared to the prior art. By the invention, the method is made simpler because it comprises fewer operational steps than the prior art methods. Thanks to the simple character, the possibility of errors is reduced and maintenance requirements are lesser. Further, the rate of processing the mail items is improved by the smaller amount of operational steps. In addition, the mail items appear more individualized and neater as there is no need of printing them with codes, which is indicative of automatic processing.

### LIST OF FIGURES

In the following section, the invention will be described in detail with reference to the accompanying drawing in which the different steps of the method according to the invention are described as a flowchart presentation.

### DETAILED DESCRIPTION OF THE INVENTION

The method according to the invention is illustrated schematically in the drawing. The printer 3 used in the method comprises two sheet feeder devices 6 and 7, i.e. in practice normally paper trays, so that two sheets of different sizes, a large one 1 and a small one 2, may be used in the printer substantially simultaneously, i.e. alternately, in a required completely free order. Printing is controlled by a file 5 which stores envelope information and letter information to be printed on the sheets.

As mail items including an envelope are prepared from the information of the file 5, the printer prints, controlled by the data of the file, on the larger sheet 1 specific envelope information, i.e. normally the name and the address information of the recipient and optionally sender information. Of course, also other visual or verbal information may be printed on the envelope sheet 1 as desired. This other information may be the same for all printouts or it may be specific for each individual envelope. However, no codes or the like are printed that would be needed during later automatic identification of the envelope sheet.

Next, the letter sheet or the letter sheets 2 which may be one or more according to need in each case and which are designated for the printed envelope sheet 1 are printed by the printer 3. Thus, the printer 3 outputs a train of ready-printed sheets 1 and 2 in such order that the envelope sheet 1 of a specific mail item to be prepared is first in train, followed by the letter sheets 2 corresponding to the envelope sheet, i.e. letters which are to be folded inside the envelope folded from the envelope sheet. In a completely corresponding manner, the sheets in train may move so that the letter sheets move first and the corresponding envelope sheet last.

The ready-printed sheets of a right size, i.e. moving uncut through the entire process, are led to folding 4. The printing and the folding constitute a substantially continuous collective process, wherein the printing 3 controls the folding by a control signal 9. In this manner, the folding need not separately read and identify the sheets which have been led to the folding, but instead, based on the control signal, the envelope sheets 1 are glued and folded to form envelopes and the letter sheets 2 are folded to form letters which fit into the envelopes. The envelope sheets and the letter sheets are folded either together or separately. Finally, the envelopes are closed to form finished mail items 8.

At the simplest, the control signal provides for the folding information for example of the envelope sheets only, i.e. sheets which are glued and folded to form the envelopes, whereby the folding processes the other sheets as letter sheets.

The drawing presents also another embodiment wherein the sheets are identified in the train before folding only by identifying the size of the sheets. In this case, a detector 11 provides a control signal 10 for the folding. In this embodiment as well, it suffices to identify only the larger envelope sheets, and the other, i.e. the smaller, sheets are processed as letter sheets, or the other way round, i.e. to identify only the smaller sheets.

In the method presented in the drawing, irrespective of the way in which the folding is controlled, the essential feature is that two sheet feeder devices 6 and 7 are used in the printer 3, comprising right from the beginning sheets of different sizes which are applicable for the purpose. In this manner, there is no need to cut the sheets at any point, but instead both of them are completely ready for their application in size and shape. Further, it is essential that only information that one intends to communicate to the recipient of the mail item is printed on the sheets in the printer. No code or the like associated with the preparation of the mail item is printed on the sheets. In this manner, there is no need for cutting operations or reading operations to identify the sheets and differentiate between them in the process of preparing the mail item from the rectangular blank sheets up to the closed mail items.

The invention is not limited merely to the examples referred to above; instead, many variations are possible within the scope of the inventive idea defined by the claims.

1. A method for preparing a mail item including an envelope from rectangular sheets (1,2) of two different sizes in a printer (3) and a folding machine (4) coupled after the printer, the method comprising use of a file (5) containing envelope information and letter information to be printed and, controlled by the file, selectively taking sheets from sheet feeder devices (6,7) of the printer in a sequential train wherein the envelope information is printed on a larger envelope sheet (1) and the letter information is printed on a smaller letter sheet (2), the printing being carried out on the employed sheets in a sequential train in one printer, characterized in that the envelope sheet (1) and the letter sheet (2) are both led from the sheet feeder devices (6,7) into the printer (3) and from the printer after printing as such, uncut and uncoded, to folding (4) wherein, controlled by the sheet size, the envelope sheet is glued and folded to form an open envelope inside which the letter sheet of that same mail item is folded, whereupon the envelope is closed to form a finished closed mail item (8).

2. The method according to claim 1, characterized in that control (9) by the sheet size is provided by a signal from the printer (3).

3. The method according to claim 1, characterized in that control (10) by the sheet size is provided by a detector (11) in connection with folding, identifying the size of the sheet which is entering the folding.

4. The method according to claim 3, characterized in that only the envelope sheets are identified, the unidentified sheets being processed as letter sheets.

5. The method according to claim 1, characterized in that one mail item comprises a number of letter sheets to be printed, whereby the envelope sheet and all associated letter sheets are printed in a sequential train.

6. The method according to claim 1, characterized in that the envelope sheet is first printed and led to folding, followed by the letter sheets of that same mail item.

7. The method according to claim 1, characterized in that the letter sheet or the letter sheets of the same mail item are first printed and led to folding, followed by the envelope sheet of that same mail item.

8. The method according to claim 1, characterized in that the envelope sheet and the associated letter sheet or letter sheets are folded together and simultaneously to form an envelope containing the letters.
